(19) United States
(12) Patent Application Publication
(10) Pub. No.: US 2014/0248108 A1
(43) Pub. Date: Sep. 4, 2014

(54) POSITIONING OF A MOTOR VEHICLE AND VEHICLE POWER SUPPLY BATTERY EXCHANGE

(71) Applicants: Alain Bachir, Saint Germain De La Grange (FR); Florent Jardel, Saint-Ouen (FR)

(72) Inventors: Alain Bachir, Saint Germain De La Grange (FR); Florent Jardel, Saint-Ouen (FR)

(73) Assignee: RENAULT s.a.s., Boulogne-Billancourt (FR)

(21) Appl. No.: 14/130,194

(22) PCT Filed: Jun. 5, 2012
(86) PCT No.: PCT/FR2012/051254

§ 371 Date: May 21, 2014

(30) Foreign Application Priority Data
Jul. 1, 2011 (FR) 1155925

(51) Int. Cl. B60S 5/06; B60L 11/18; B60S 13/00

(52) U.S. Cl. CPC B60S 5/06; B60S 13/00; B60L 11/18
USPC 414/222.01; 414/800; 414/806

(57) ABSTRACT

A positioning of a motor vehicle in absence of action of a motor or engine that drives the motor vehicle includes centering the vehicle transversely with respect to a longitudinal-vertical reference plane that is invariable in a fixed frame of reference until a center of a first axle of the vehicle coincides or more or less coincides with the reference plane whatever the gauge width of the first axle of the vehicle.

### TECHNICAL FIELD OF THE INVENTION

The invention relates to a method and a device for positioning a motor vehicle with respect to a fixed frame of reference and also relates to a method and a system for exchanging a battery that supplies power to a motor that drives an electric or hybrid motor vehicle.

### PRIOR ART

Some motor vehicles, such as electric or hybrid vehicles, comprise a container containing power for supplying an electric drive motor, said container being of the electric power supply battery type. In the description that follows, the term “battery” will be used, for reasons of simplification, to denote in a broad sense any container that supplies electrical power to an electric motor that drives a vehicle. It may be beneficial to exchange this battery when its energy level is low for a new, charged battery. This can be carried out in an exchange station, such as a station similar to a service station for refilling tanks associated with combustion engines.

In such exchange stations in particular, there is the key problem of positioning the vehicle so that the battery can be exchanged. It is necessary to position the vehicle precisely, but in order to enable easy development of battery exchange solutions, it is necessary to make the functioning of exchange solutions, in particular vehicle positioning devices, reliable, simple and robust whilst limiting their cost.

A difficulty encountered when implementing such a vehicle positioning concept lies in the fact that there may be a multitude of motor vehicles potentially having different dimensions and variable wheelbases and front and rear track widths. It is therefore necessary to provide a vehicle positioning solution that is also versatile and universal so as to be able to adapt in a simple manner to these variable parameters.

A station for exchanging batteries that supply electrical power to an electric motor that drives an electric vehicle and a method for carrying out such an exchange are known from document US2010/145717. The exchange station described comprises a means for assembling and disassembling a battery in/from a vehicle. The vehicle is positioned primarily by the driver, means for detecting the position of the vehicle then allowing the assembly/disassembly means to be positioned relative to the vehicle. There is therefore no management per se of the positioning of the vehicle, which makes it very complex for the assembly/disassembly means to compensate for the positioning discrepancies between the vehicles with each new exchange procedure, this also being unreliable and onerous.

Document US2008/0294283 describes a solution for exchanging the battery that supplies power to a motor that drives a motor vehicle using a positioning of the vehicle in the station via optical means ensuring continuous detection of the longitudinal and transverse position of the vehicle. The central unit receiving this information remotely steers the vehicle automatically with no action on the part of the driver so as to position the vehicle at a given location within the station. It is quite clear that this solution is complex and onerous, the large number of sensors and electronic means necessary for the operation of such a station making it unreliable, implying that the operation of said station is not robust. On the other hand, this solution is reserved only for vehicles that allow remote steering, which considerably restricts the applications.

Document FR20090054582 describes a vehicle positioning solution in which only a longitudinal positioning of the vehicle is ensured with respect to a fixed frame of reference, but no transverse positioning. In fact, on the contrary, the vehicle remains continually in the same transverse position during the battery exchange, whereas sensing means come to rest against the lateral faces of the vehicle, for example come to rest against the two lateral faces of the rear axle wheels of the vehicle. Thanks to the data provided by the sensing means, it is the battery assembly and disassembly device that can be positioned with respect to the vehicle. Such a solution therefore bestows these constraints on the design of the assembly/disassembly device.

Document US2011/0044791 describes a battery exchange solution implementing a longitudinal positioning of the vehicle with respect to the ground, then a transverse positioning in which the entire vehicle is displaced transversely until the inner flank of the left tire of at least one of the axles contacts a transverse stop fixed to the ground. In this solution, the position of the median longitudinal-vertical plane of the vehicle thus occupies a variable position in the transverse direction depending on the front and rear track widths of the vehicle. Again, such variations in positions of the vehicle in the transverse direction depending on the type of vehicle result in complex management and design of the device for assembling and disassembling the battery in/from the vehicle or of any other device intended to interact with the vehicle in order to compensate for the positioning discrepancies. The vehicle positioning solution therefore is not versatile and universal according to the type of vehicle and makes the battery exchange solution onerous and unreliable due to the constraints associated with the battery assembly/disassembly device.

### OBJECT OF THE INVENTION

The object of the present invention is to overcome these disadvantages by proposing a solution for positioning a motor vehicle with respect to a fixed frame of reference, said solution being versatile and universal and making it possible to facilitate the related operations for which the positioning of the vehicle is necessary.

A first aspect of the invention relates to a method for positioning a motor vehicle comprising a longitudinal axis, a transverse axis and a vertical axis with respect to a fixed frame of reference comprising a reference longitudinal axis, a reference transverse axis and a reference vertical axis in the absence of action of a motor or engine that drives the motor vehicle. The method comprises a first step of transversely centering the vehicle with respect to a reference longitudinal-vertical plane that is invariable in the fixed frame of reference until the center of a first axle of the vehicle, preferably the rear axle but possibly the front axle, coincides or substantially coincides with the reference plane, whatever the track width of the first axle of the vehicle.

The first centering step may comprise a provision of free movability of the vehicle along the reference transverse axis with respect to the fixed frame of reference and an application of forces to the vehicle so as to displace the vehicle. The forces can be applied over two elements of the vehicle that are symmetrical relative to a median longitudinal-vertical plane associated with the vehicle, in particular two wheels of the first axle, by two centering elements forced to be displaced symmetrically to one another relative to the reference plane.

The positioning method may comprise a second step of positioning the vehicle with respect to the fixed frame of reference, comprising:
a positioning of the vehicle with respect to the fixed frame of reference along the reference longitudinal axis, and/or
a positioning of the vehicle with respect to the fixed frame of reference about the reference vertical axis so as to make a median longitudinal-vertical plane of the vehicle coincide with the reference longitudinal-vertical plane.

The second positioning step may comprise the placing of the two wheels of the first axle of the vehicle in a longitudinal positioning element by lowering a support element on which these wheels rest during the first centering step.

The positioning method may further comprise a step of immobilizing the vehicle with respect to the fixed frame of reference, said step possibly being combined with the second positioning step. In the latter case, the second positioning step and the immobilizing step may comprise the establishment of a free relative sliding of the wheels not cooperating with the longitudinal positioning element along the reference longitudinal axis with respect to the floor, which is fixed in the fixed frame of reference.

The positioning method may also comprise a step of leveling the vehicle with respect to the floor fixed in the fixed frame of reference, comprising:
a positioning of the vehicle body with respect to the floor along the reference vertical axis, and/or
a positioning of the vehicle body with respect to the floor about the longitudinal axis, and/or
a positioning of the vehicle body with respect to the floor about the transverse axis.

A second aspect of the invention relates to a method for exchanging a battery that supplies power to a motor that drives an electric or hybrid motor vehicle, comprising a step of positioning the vehicle with respect to a battery exchange system, this positioning being achieved by implementing a positioning method as mentioned above.

This exchange method may comprise a step of pre-positioning of the vehicle by the driver with respect to the exchange system prior to the positioning step, comprising active guidance on the part of the driver at a driver/exchange system interface. The pre-positioning step may comprise a determination of the actual position of the vehicle with respect to the fixed frame of reference, at least along the reference transverse and longitudinal axes.

The establishment of the free relative sliding of the wheels along the reference longitudinal axis with respect to the floor can be controlled during the opening of a hatch arranged beneath the vehicle to the right of the battery so as to enable said battery to be assembled and disassembled relative to the vehicle.

Moreover, the exchange method may comprise a removable arrangement of refueling elements between the vehicle body and the floor surrounding the hole that the hatch is intended to close.

A third aspect of the invention relates to a device for positioning a motor vehicle with respect to a fixed frame of reference, said device comprising hardware means and/or software means for implementing a positioning method as mentioned above.

A fourth aspect of the invention lastly relates to a system for exchanging a battery that supplies power to a motor that drives an electric or hybrid motor vehicle, comprising a positioning device as mentioned above. The exchange system may comprise hardware and/or software means for implementing an exchange method described above.

### BRIEF DESCRIPTION OF THE DRAWINGS

Further advantages and features will become clearer from the following description of specific embodiments of the invention provided by way of non-limiting example and illustrated in the accompanying drawings, in which:

FIG. 1 is a perspective view from above of an example of a positioning device according to the third aspect of the invention in an example of the exchange system according to the fourth aspect of the invention,

FIG. 2 illustrates a perspective view from above of a front plate of the device in FIG. 1,

FIG. 3 illustrates a perspective view from above of a rear plate of the device in FIG. 1,

FIG. 4 is an exploded view of the assembly of the positioning device in FIG. 1 in part of the exchange system.

### DESCRIPTION OF PREFERRED EMBODIMENTS OF THE INVENTION

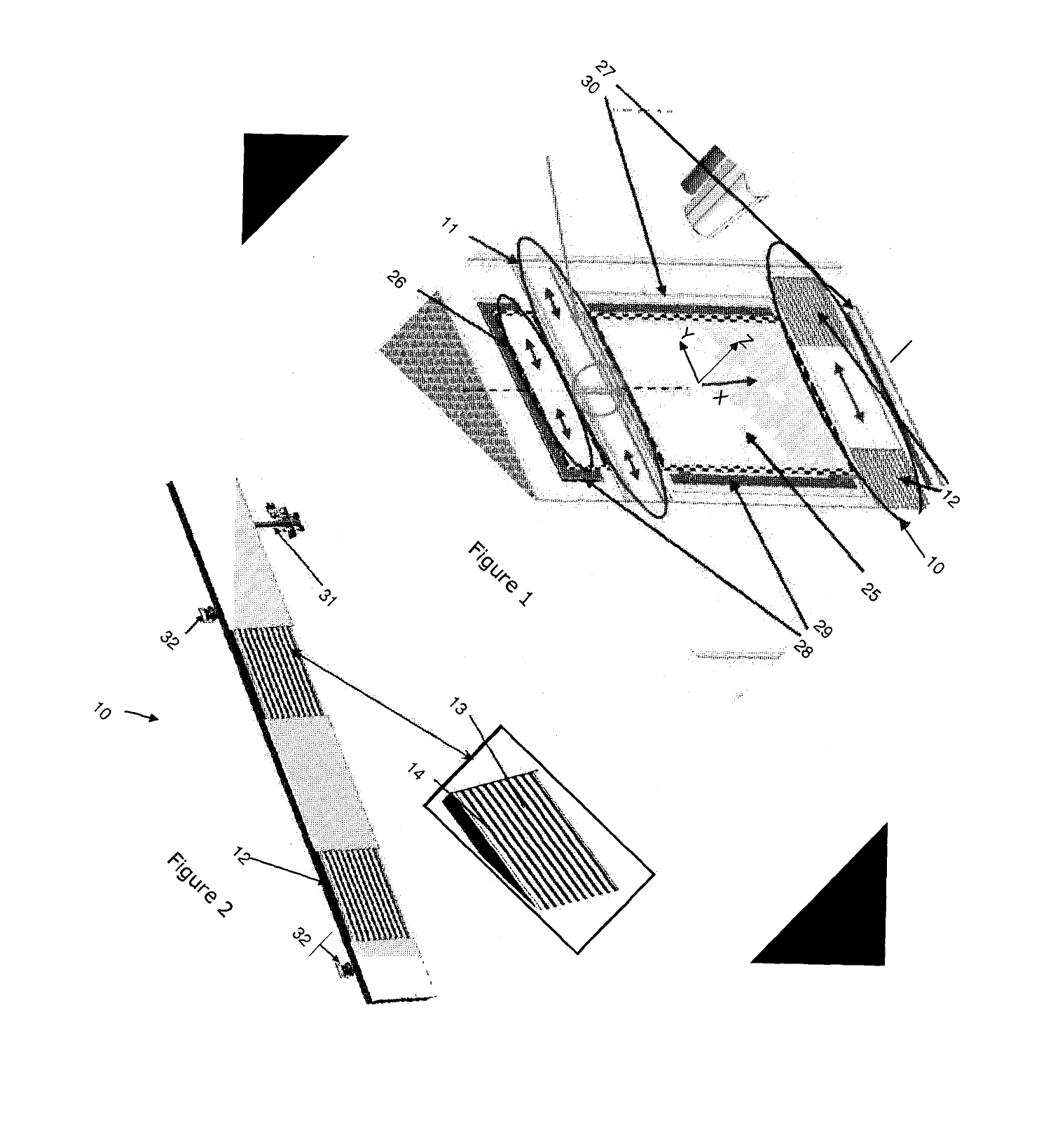

The positioning device shown in FIG. 1 is intended to ensure the positioning of a motor vehicle with respect to a fixed frame of reference in the absence of action of a motor or engine that drives the motor vehicle. By way of non-limiting example, the positioning device is used in the arrangement of a station for exchanging batteries that supply power to the drive motor so as to position the vehicle with respect to the floor of the station for operations involving the assembly and disassembly of a battery in/from the vehicle.

The fixed frame of reference comprises a reference longitudinal axis X, a reference transverse axis Y and a reference vertical axis Z, whereas the vehicle bears a mobile frame of reference comprising a longitudinal axis, a transverse axis and a vertical axis (not shown).

The concept of the positioning solution according to the invention lies primarily in the completion of a first step of centering the vehicle along the axis Y in a manner that will be described further below. A second step of positioning the vehicle can then be carried out by positioning the vehicle along the axis X and/or about the axis Z. The vehicle is then possibly immobilized relative to the fixed frame of reference (X, Y, Z) after the second step or in a manner combined with the second step. Lastly, the vehicle may possibly be leveled by a positioning of the vehicle body with respect to the floor along the axis Z and/or about the longitudinal and/or transverse axis associated with the vehicle.

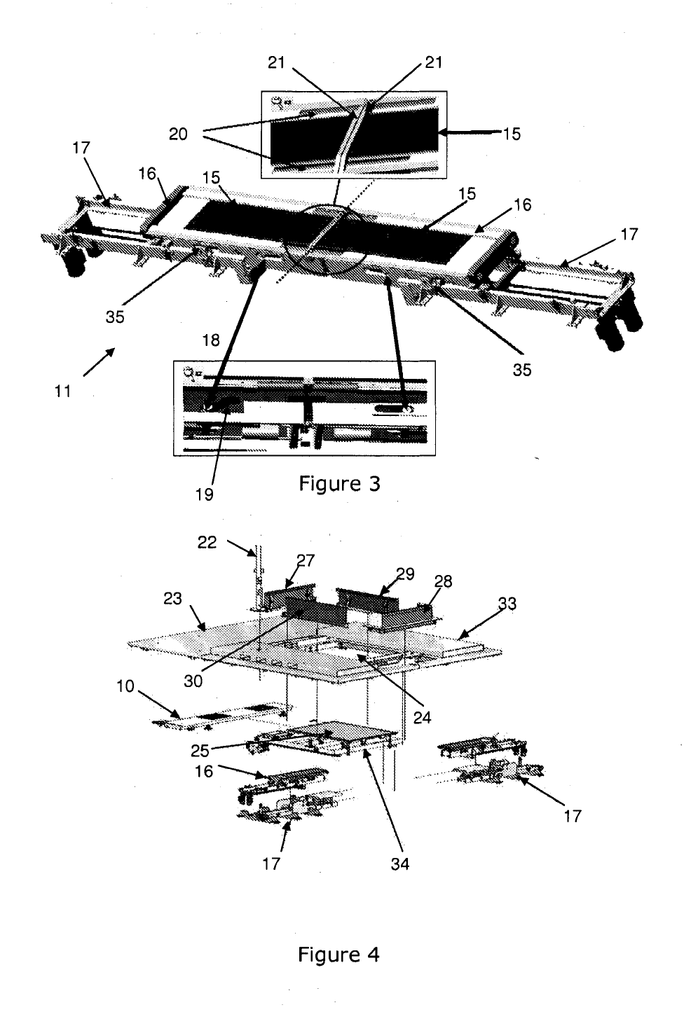

In principle, the positioning device comprises a front plate 10 and a rear plate 11 devoted to these operations and illustrated in detail in FIGS. 2 and 3 respectively. The front plate 10 is intended to support the wheels of the front axle of the vehicle during positioning thereof, whereas the rear plate 11 is intended to support the wheels of the rear axle of the vehicle during positioning thereof.

The front plate 10 is mounted such that it can be moved as a whole in translation with respect to the fixed frame of reference, in particular with respect to the floor, along the reference transverse axis Y. This movability in translation along the axis Y achieved by sliding rollers 32 serves to allow the vehicle resting on the front plate 10 by the wheels of its front axle to be freely moved along the axis Y with respect to the fixed frame of reference. The vehicle can thus be displaced along Y under the effect of transverse centering forces applied to the vehicle at the rear axle, as explained below.

In addition, the front plate 10 is equipped with two bearing zones 12 for the front wheels, each of said bearing zones 12 being equipped with a device suitable for establishing or, conversely, inhibiting a relative sliding of a front wheel along the reference longitudinal axis X with respect to the floor, which is fixed in the fixed frame of reference. The sliding of a front wheel along the axis X, corresponding specifically to the provision of a local movability of the front wheel with respect to the floor at the point of contact between this wheel and the floor, thus allows a free rotation of this wheel (for example in the event of application of a motor or engine force to this wheel) whilst keeping the vehicle fixed, and/or a translation of this wheel along the axis X in the event of a displacement in translation of the vehicle as a whole along the axis X. Such a device may thus comprise a plurality of parallel rollers 13 mounted independently on the rest of the front plate 10 by being oriented along the axis Y and offset from one another along the axis X. The device may also comprise wheel grip elements 14, for example in the form of retractable ridges, intended to vary, by actuation of a jack 31, between a removed position beneath the rollers 13 allowing the relative sliding between the wheel and floor by rotation of the rollers 13, and a position protruding from the rollers 13 along the axis Z, preventing the relative sliding as a result of grip between the elements 14 and the wheel and thus allowing the wheel to transmit a motor or engine force with respect to the floor.

The provision of the free movability along Y in the first centering step can be obtained with the aid of a front plate fixed with respect to the floor in the frame of reference. In this case, the rollers 13 can move along Y with respect to the rest of the front plate.

The rear plate 11 is composed of a right-hand assembly and a left-hand assembly, which are identical and are arranged symmetrically with respect to a reference longitudinal-vertical plane (X, Z) fixed with respect to the fixed frame of reference, having a normal vector collinear with the reference transverse axis Y. Each of these assemblies comprises a support element 15, on which one of the wheels of the rear axle is intended to come to rest at the moment at which the vehicle is placed on the positioning device. Each of these support elements 15 is mounted freely in translation along the reference axis Y with respect to an associated slide 16, itself mounted in translation by rollers 35 along the reference axis Y with respect to a frame 17 accommodated fixedly below the floor relative to the fixed frame of reference. The frame 17 further comprises means for executing the movement in translation along the axis Y of the slide 16 and/or of the support element 15. The slides 16 may vary between a closed configuration in contact with one another via their distal transverse end and an open configuration in which the slides 16 are at a distance from one another. The assembly of the support element 15 on the corresponding slide 16 requires a degree of freedom of the support element 15 along the axis Z with respect to the slide 16, for example with the aid of a lifting roller 18 that is fixed with respect to the slide 16 and slides along an elongate opening 19 which is formed in the element 15 and which, over its length, has a deviation having a component along the axis Z. The assembly is designed such that the position of the support element 15 may vary along Z, under the effect of a relative sliding motion in Y with respect to the slide 16, between a position protruding with respect to the independently mounted rollers 20 oriented along the axis Y and offset along the axis X, and a position removed beneath the independently mounted rollers 20. When the wheels of the rear axle rest on the support elements 15, the two support elements 15 which adopt the position protruding with respect to the independently mounted rollers 20 thus form an assembly integral with the vehicle and mounted so as to move freely in translation along the axis Y with respect to the slides 16, and lastly with respect to the floor. The two support elements 15, under the effect of the gravity applied by the vehicle at the wheels of the rear axle, are displaced jointly with the vehicle along the axis Y as the vehicle is centered along Y. If, by contrast, the support elements 15 are lowered, the wheels of the rear axle are lowered simultaneously until they come to rest on the independently mounted rollers 20, and the contact between the wheels and the support elements 15 is cancelled. The assembly of the element 15 on the corresponding slide 16 may require either an automatic lowering of the element 15 beyond a certain opening of the slides 16, or a selective lowering controlled specifically. The support elements may thus then move freely in translation along Y with respect to the floor and with respect to the vehicle, whereas the slides 16 equipped with rollers 20 become integral with the vehicle under the effect of gravity. The support elements 15 may be provided in order to then spread apart sufficiently transversely to give access to the rear axle assembly from below.

The slides 16 are intended to allow an application of mechanical forces to the vehicle in order to carry out a step of centering the vehicle along the transverse axis Y with respect to the fixed frame of reference. More specifically, the centering process consists of displacing the vehicle transversely with respect to a reference longitudinal-vertical plane (X, Z) that is invariable in the fixed frame of reference, whereas the vehicle as a whole is mounted in translation along Y by resting on the front plate 10 by its front wheels and on the support elements 15 by its rear wheels, this displacement consisting in making the center of a first axle of the vehicle coincide or substantially coincide with the reference plane, whatever the track widths of the vehicle.

In the foregoing, the track width corresponds to the distance or spacing between the two wheels belonging to the same axle, whether the front or rear axle. Specifically, the track width measures the distance between the centers of the zones of contact between the wheels belonging to the same axle and the ground. It is often the case that a vehicle has a different front track width and rear track width. Depending on the type of suspension, the track width may vary with the load, the track width thus corresponding to the measurement of the empty distance.

In the specific example described here, the slides 16 are intended to make the center of the rear axle coincide or substantially coincide with the reference plane (X, Z). For this, centering forces are applied to the vehicle over two symmetrical elements of the vehicle relative to a median longitudinal-vertical plane associated therewith, in particular two wheels belonging to the same axle (for example the two inner flanks of the wheels belonging to the rear axle), by two centering elements 21 carried by the slides 16 and forced to be displaced symmetrically to one another relative to the reference plane (X, Z). For each assembly of the rear plate 11, the centering element 21 is arranged for example at the end of the slide 16 opposite the other assembly. By way of example, the centering elements 21 are in contact with one another in a closed configuration of the slides 16. The transfer of the slides 16 into an open configuration, by sliding said slides along the reference axis Y relative to the frame 17, causes a symmetrical displacement of the centering elements 21 with respect to one another relative to the reference plane, this displacement being sustained until firstly one of these elements 21 contacts the inner flank of a rear wheel, then until the other element 21 contacts the inner flank of the other rear wheel. During said displacement of the slides 16, the support elements 15 remain stationary during a first period of time, whereas the elements 21 are displaced along elements 15 in the direction Y, for example thereabove. Between the two instances of contact, the movement of the slide 16 carrying the element 21 already in contact ensures a transverse displacement in translation of the vehicle so as to thus ensure the transverse centering of said vehicle. The displacement of the vehicle is interrupted as the other centering element 21 comes into contact with the other rear wheel, the vehicle then being centered transversely such that the center of its rear axle coincides with the reference plane. Means for measuring and/or controlling the contact pressure between the flanks of rear wheels and the centering elements 21 may be provided in order to control the interruption of the displacement as the slides 16 are opened beyond a predetermined pressure value. Should the centering elements be intended to act on symmetrical elements of the vehicle offset longitudinally with respect to the first axle, a minor offset in the order of a few millimeters could be envisaged between the reference plane and the center of the first axle.

At the end of such a first step of transversely centering the vehicle, a second step of positioning the vehicle may be provided in order to ensure the positioning of said vehicle along the reference longitudinal axis X with respect to the fixed frame of reference and/or in order to compensate for alignment defects between the reference longitudinal axis X and the longitudinal axis associated with the vehicle. It is for this reason that, following the transverse centering of the vehicle corresponding to the first step, the support elements 15 on which the rear wheels rest during the first centering step may be lowered until each of the two rear wheels are placed in the longitudinal space between the corresponding independently mounted rollers 20, transferring the wheel to the two rollers 20, said space and the rollers of the two assemblies of the rear plate 11 contributing to the provision of an element of longitudinal positioning of the vehicle. During said second positioning step resulting from the placement of the rear wheels on the independently mounted rollers 20, the positioning of the vehicle thus obtained with respect to the fixed frame of reference thus comprises a positioning of the vehicle with respect to the fixed frame of reference along the reference longitudinal axis X (the rollers 20 being fixed in the fixed frame of reference along the axis X) and/or about the reference vertical axis Z so as to make a median longitudinal-vertical plane of the vehicle coincide with the reference longitudinal-vertical plane (X, Z). It is in order to make it possible to thus position the vehicle in the event that the rear wheels are blocked (by pressing on the brake pedal or by triggering the parking brake) that the rollers 20 with which the rear wheels cooperate are mounted independently relative to the slides 16. Similarly, it is in order to make the vehicle movable along the reference longitudinal axis X during the second positioning step in spite of a blockage of the front wheels (for example by pressing on the brake pedal or potentially by triggering the parking brake) that a free relative sliding of the front wheels with respect to the floor has been established along the reference longitudinal axis X.

The placement and the dimensions of the bearing zones 12 and of the support elements 15 along the reference axes X and Y may be selected so as to ensure the positioning of any type of waiting vehicle, in particular independently of the corresponding wheelbases and track widths of these vehicles, i.e. the front or rear track widths depending on the plate in question.

An immobilization with respect to the fixed frame of reference of a vehicle having undergone the positioning corresponding to the two steps described beforehand, in other words the first step of transversely centering the vehicle and the second positioning step, may be provided. In the example described here, this immobilization step is combined with the second positioning step, but this could alternatively consist of a separate and subsequent step. In fact, at the end of the second positioning step, the rear wheels are longitudinally blocked by the rollers 20, whereas the front wheels rest on the bearing zones 12 with provision of a relative sliding between the front wheels and bearing zones 12 along the reference longitudinal axis X, such that no transmission of power from the front wheels to the floor is possible. The vehicle is thus immobilized along the reference longitudinal axis X, whereas at least the grip of the rear wheels on the independently mounted rollers 20 under the effect of gravity ensures the immobilization of the vehicle along the reference transverse axis Y with respect to the fixed frame of reference. The ongoing bearing of the centering elements 21 against the rear wheels may also contribute to the transverse immobilization of the vehicle. To inhibit the immobilization of the vehicle along the reference longitudinal axis X, it is sufficient then to place the grip elements 14 in the position protruding with respect to the rollers 13 along the axis Z so as to prevent the relative sliding of the front wheels and to thus allow the wheel to transmit a motor or engine force with respect to the floor.

Furthermore, elements for leveling the vehicle with respect to the floor fixed in the fixed frame of reference may be provided. These elements 22 are visible in FIG. 4 and may be formed by any suitable means, for example a plurality of jacks (for example four) mounted on the floor, movable in X and in Y and ensuring a lifting function in Z. Depending on the design of the battery and on the content of the exchange procedures, it is possible to provide only two of these elements, for example in the vicinity of the front right and left wheels. These elements are generally intended to create a local or overall lifting of the vehicle body in order to position the vehicle body with respect to the floor along the reference vertical axis and/or about the longitudinal axis associated with the vehicle and/or about the transverse axis associated with the vehicle. In other words, the vehicle is brought into a level determined by this positioning.

In the above-described positioning solution (device and method), the roles of the front and rear axles may be indifferently reversed without departing from the scope of the invention by reversing the front and rear plates.

The device for positioning a motor vehicle with respect to a fixed frame of reference thus comprises hardware means 10, 11, 12, 13, 14, 15, 16, 17, 18, 19, 20, 21, and/or software means for implementing a positioning method as described above. In particular, the device comprises a means 10, 11, 12, 16, 21 for transversely centering the vehicle with respect to a reference longitudinal-vertical plane that is invariable in the fixed frame of reference in order to make the center of a first axle of the vehicle coincide or substantially coincide with the reference plane, whatever the track width of the first axle of the vehicle. The device may further comprise a means 10, 11 for providing a free movability of the vehicle with respect to the fixed frame of reference along the reference transverse axis and/or a means 16, 21 for applying forces to the vehicle so as to displace the vehicle transversely, and/or a longitudinal positioning element 20 in which the two wheels of the first axle of the vehicle are placed by means 18, 19 for lowering a support element 15 and/or a means for immobilizing the vehicle with respect to the fixed frame of reference and/or a means 13, 14 for establishing a free relative sliding of the wheels not cooperating with the longitudinal positioning elements along the reference longitudinal axis with respect to the floor, which is fixed in the fixed frame of reference, and/or a means for leveling the vehicle with respect to the floor fixed in the fixed frame of reference.

The positioning of the vehicle obtained by all the operations described above makes its possible, for example, to localize the vehicle with respect to the floor and with respect to a battery exchange system with a level of accuracy significantly greater than the positioning accuracy prior to the use of the positioning device, for example after the pre-positioning of the vehicle by the driver. The obtained positioning accuracy is, for example, approximately more or less 1 mm, which cannot be implemented repeatedly by a mere pre-positioning by the driver.

The solution for positioning a vehicle with respect to a fixed frame of reference, said solution being described above, may have numerous applications, for example when it is necessary to exchange a battery that supplies power to a drive motor in the vehicle in the event that the vehicle has an electric or hybrid powertrain. This exchange requires, in fact, assembly and disassembly of the battery within a battery exchange system or station, and these procedures require a positioning of the vehicle to which they are applied with respect to a fixed frame of reference associated with the exchange system, which conventionally comprises a platform or surface 23 visible in FIG. 4. The device for positioning a vehicle with respect to a fixed frame of reference, said device comprising hardware means and/or software means for implementing all or some of the above-described positioning steps, may thus be used to bring a battery exchange station or system into position whilst being arranged level with or below the platform 23. In particular, the front and rear plates 10, 11 may be arranged in the way of an opening 24 formed in the platform 23, such that the vehicle can come to rest its wheels on the plates 10, 11 by passing above the opening 24, which may be closed horizontally by one or more sliding doors 33. The purpose of the positioning solution described above is therefore to position the vehicle of which the battery is to be exchanged with respect to a battery exchange system comprising on the one hand the platform 23 and on the other hand a battery assembly and disassembly device (not shown) located beneath the platform 23, for example in a compartment formed beneath the vehicle. More specifically, the battery assembly and disassembly device has an access point to the vehicle battery from beneath, by passing through a hole 34 formed to the right of the opening 24 in the platform 23, between the front and rear plates 10, 11 and/or to the rear of the rear plate 11 along the axis X, depending on the placement of the battery onboard the vehicle. The battery exchange system may thus comprise the arrangement of a central hatch 25 between the two front and rear plates 10, 11 and/or a rear hatch 26 to the rear of the rear plate 11. These hatches 25, 26 can be removed by any suitable means so as to allow the assembly and disassembly of the battery through the hole 34 that the hatch is intended to close. The central hatch 25 allows access to a battery assembled on the vehicle between the front and rear axles, whereas the rear hatch 26 allows access to a battery that can be housed in the luggage compartment of the vehicle.

In order to make it possible to place the vehicle on the positioning device housed beneath the platform 23 in order to accurately position the vehicle with respect to the battery assembly/disassembly device, the battery exchange system may comprise means designed to ensure a pre-positioning of the vehicle by the driver himself with respect to the exchange system, in particular the platform 23. This pre-positioning may comprise active guidance on the part of the driver at a driver/exchange system interface. This interface aiding the pre-positioning may be a screen making it possible to give the driver visual instructions in order to indicate to him in real time the driving operations that must be carried out by him in order to pre-position the vehicle in the intended manner with respect to the platform 23. This interface may additionally or alternatively implement the transmission of audible instructions intended for the driver. In order to implement active guidance of this type, the actual position, in real time, of the vehicle during pre-positioning with respect to a fixed frame of reference associated with the battery exchange system may be determined at least along the reference longitudinal axis X and the reference transverse axis Y. This determination may be accomplished with the aid of optical, laser or other position sensors arranged transversely and longitudinally in order to determine the actual position of the vehicle along the axis Y and along the axis X respectively.

Prior to such pre-positioning, it is conceivable to provide remote vehicle recognition, for example thanks to a solution including an RFID chip, in order to anticipate a potential choice of assembly/disassembly device and/or battery type in the storage and/or electrical recharging zone depending on the type of vehicle.

A process of washing and possible drying of the vehicle, in particular of the battery that it carries, may possibly be provided after vehicle recognition and prior to the installation of the vehicle on the positioning device.

In a variant having enhanced safety, it is possible for the removed position of the grip elements 14 beneath the rollers 13 allowing the relative sliding between the wheel and the floor to be controlled as the hatch 25 and/or 26 formed beneath the vehicle to the right of the battery is opened in order to allow the battery to be disassembled and disassembled relative to the vehicle. Any transmission of force to the floor from the motor-driven wheels is thus inhibited as long as the hatch 25 and/or 26 is open, thus limiting the risks of objects or individuals falling through the holes 34 that the hatches 25/26 close. To further limit these risks, it is possible to provide (see FIG. 4) a removable arrangement of refueling elements between the vehicle body and the floor surrounding the hole 34 that the hatch(es) is (are) intended to close. These elements may be formed by front and rear skirts 27, 28 arranged transversely and offset longitudinally, and by lateral skirts 29, 30 arranged longitudinally and offset transversely. The skirts 27 to 30 are retractable beneath the upper level of the platform 23 and come just into the vicinity of the vehicle body surrounding the battery when they are raised in a manner protruding from the platform.

Lastly, the battery exchange system may include all the hardware and/or software means for implementing all or some of the above-described steps in order to exchange a battery.

The technical solution is functional whatever the uses of the driver:
rotation of the steering wheel (front wheels),
pressing on the brake pedal,
pressing on the accelerator (the vehicle being stationary thanks to the rollers),
handbrake actuated or vehicle with automatic brake,
vehicle with automatic transmission, whatever the position of the gear lever (park, drive, neutral or reverse).

1-19. (canceled)

20: A method for positioning a motor vehicle including a longitudinal axis, a transverse axis, and a vertical axis with respect to a fixed frame of a reference including a reference longitudinal axis, a reference transverse axis, and a reference vertical axis in absence of action of a motor or engine that drives the motor vehicle, the method comprising:
a first centering of transversely centering the vehicle with respect to a reference longitudinal-vertical plane that is invariable in the fixed frame of reference until a center of a first axle of the vehicle coincides or substantially coincides with the reference plane, whatever a track width of the first axle of the vehicle.

21: The positioning method as claimed in claim 20, wherein the first centering comprises a provision of a free movability of the vehicle with respect to the fixed frame of reference along the reference transverse axis.

22: The positioning method as claimed in claim 21, wherein the first centering comprises an application of forces to the vehicle to displace the vehicle transversely.

23: The positioning method as claimed in claim 22, wherein the forces are applied over two elements of the vehicle that are symmetrical relative to a median longitudinal-vertical plane associated with the vehicle by two centering elements forced to be displaced symmetrically to one another relative to the reference plane.

24: The positioning method as claimed in claim 23, wherein the symmetrical vehicle elements are two wheels of the first axle.

25: The positioning method as claimed in claim 20, further comprising second positioning the vehicle with respect to the fixed frame of reference, comprising:
positioning the vehicle with respect to the fixed frame of reference along the reference longitudinal axis, and/or
positioning the vehicle with respect to the fixed frame of reference about the reference vertical axis to make a median longitudinal-vertical plane of the vehicle coincide with the reference longitudinal-vertical plane.

26: The positioning method as claimed in claim 25, wherein the second positioning comprises placing two wheels of the first axle of the vehicle in a longitudinal positioning element by lowering a support element on which the wheels rest during the first centering.

27: The positioning method as claimed in claim 25, further comprising immobilizing the vehicle with respect to the fixed frame of reference.

28: The positioning method as claimed in claim 27, wherein the immobilizing is combined with the second positioning.

29: The positioning method as claimed in claim 28, wherein the second positioning and the immobilizing comprise establishment of a relative sliding of the wheels not cooperating with the longitudinal positioning element along the reference longitudinal axis with respect to the floor, which is fixed in the fixed frame of reference.

30: The positioning method as claimed in claim 20, further comprising leveling the vehicle with respect to the floor fixed in the fixed frame of reference, comprising:
positioning the vehicle body with respect to the floor along the reference vertical axis, and/or
positioning the vehicle body with respect to the floor about its longitudinal axis, and/or
positioning the vehicle body with respect to the floor about its transverse axis.

31: A method for exchanging a battery that supplies power to a motor that drives an electric or hybrid motor vehicle, comprising:
positioning the vehicle with respect to a battery exchange system, by implementing a positioning method as claimed in claim 20.

32: The exchange method as claimed in claim 31, further comprising pre-positioning the vehicle by a driver with respect to the exchange system prior to the positioning, comprising active guidance of the driver thanks to a driver/exchange system interface.

33: The exchange method as claimed in claim 32, wherein the pre-positioning comprises a determination of an actual position of the vehicle with respect to the fixed frame of reference, at least along the reference transverse and longitudinal axes.

34: The exchange method as claimed in claim 31, wherein establishment of relative sliding of the wheels along the reference longitudinal axis with respect to the floor is controlled during opening of a hatch arranged beneath the vehicle to a right of the battery to enable the battery to be assembled and disassembled relative to the vehicle.

35: The exchange method as claimed in claim 34, further comprising a removable arrangement of refueling elements between the vehicle body and the floor surrounding a hole that the hatch is intended to close.

36: A device for positioning a motor vehicle with respect to a fixed frame of reference, comprising hardware means and/or software means for implementing a positioning method as claimed in claim 20.

37: A system for exchanging a battery that supplies power to a motor that drives an electric or hybrid motor vehicle, comprising a positioning device as claimed in claim 36.

38: The exchange system as claimed in claim 37, comprising hardware and/or software means for implementing an exchange method.
